(19) United States
(12) Patent Application Publication
(10) Pub. No.: US 2007/0103545 A1
(43) Pub. Date: May 10, 2007

(54) 360 Degree display

(75) Inventors: Bernard S. Listig, Ponce, PR (US); Joseph K. Listig, Ponce, PR (US)

Correspondence Address: BANNER & WITCOFF, LTD., TEN SOUTH WACKER DRIVE, SUITE 3000, CHICAGO, IL, 60606, US

(73) Assignee: Digital Video Media, L.L.C., Deerfield Beach, FL (US)

(21) Appl. No.: 11/270,157

(22) Filed: Nov. 9, 2005

(51) Int. Cl. H04N 15/00

(52) U.S. Cl. 348/41

(57) ABSTRACT

A display apparatus capable of displaying images around a 360 degrees cylindrical surface is disclosed. The display surface may be divided into multiple segments. The display apparatus is comprised of two parts, a static cabinet-like structure that encases the complete unit, and an inner cylindrical rotating unit that creates a quantum holographic effect for display. For example, the rotating unit may be comprised of multiple vertical strips light emitting diodes (LEDs) configured to display one of many colors. The display apparatus may achieve a holographic effect through a phenomenon known as persistence of vision. A method for controlling the display apparatus for displaying images and a computer-readable medium containing instructions to perform the method is also disclosed.

### TECHNICAL FIELD

The invention relates to the display of images using multiple moving light sources. More specifically, the invention relates to a system, device, and method for displaying images around a 360 degrees surface using rotating light emitting diodes to create a holographic effect.

### BACKGROUND

Devices for displaying images have existed for some time. For example, display devices having arrangements of colored lights that are moved by rotating or swinging have been known for some time. Some of these display units were rotated by a motor and driven by a motor control signal to display images. Mostly, these display devices were used to create a fairly simple images, such as letters or numbers for an alarm clock display. For example, some display devices rendered text and graphics in a cylindrical plane to show time and date information. In addition, some of the prior art display devices relied upon chromatic mixing effects to generate colorful displays. Chromatic mixing required that multiple lights be rotated and used together to create more color palettes. Furthermore, other prior art display devices operated using polarizers to display images.

There is a need in the art for an apparatus and method for displaying video in realtime with a holographic-like effect and for displaying high resolution images. Furthermore, there is a need in the art for an apparatus and method for displaying high-quality images with a holographic-like effect in sixteen million colors.

### SUMMARY

A display apparatus for displaying images is disclosed. The apparatus is comprised of a static unit and a cylindrical rotating unit with panels of light sources. In addition, a security shield may be used around the rotating unit for protection. A motor and a belt drive system may be used to rotate the cylindrical unit and a rotary sensor may be used to read information about the rotating unit. A control panel with video and audio input jacks may also be provided. In addition, a primary video card and a plurality of secondary video cards may be provided for processing the video and image data and controlling the activation of the light sources at the appropriate time.

In addition, a method is disclosed for controlling a device for displaying images. The method includes receiving video, audio, and/or user input. The input is processed and converted into control signals for selectively activating the light sources on the display apparatus. The device is rotated and information about the rotation is read by a rotary sensor. An image and corresponding audio may be displayed and heard, respectively. Furthermore, a computer-readable medium comprising computer-executable instructions for performing the aforementioned method is also disclosed.

### BRIEF DESCRIPTION OF THE DRAWINGS

Aspects of the invention are illustrated by way of example and not limited in the accompanying figures in which like reference numerals indicate similar elements and in which:

FIG. 1 is a suitable system architecture in accordance with various aspects of the invention.

FIG. 2 is a front outer view of an illustrative display apparatus in accordance with various aspects of the invention.

FIG. 3 is a cross-section view of an illustrative display apparatus in accordance with various aspects of the invention.

FIG. 4 is an illustration of a section of a panel of light sources in accordance with various aspects of the invention.

FIG. 5 shows illustrative panels of light sources in accordance with various aspects of the invention.

FIG. 6 illustrates a cross-sectional top view of a display apparatus in accordance with various aspects of the invention.

FIG. 7 shows another cross-sectional top view of an illustrative display apparatus comprising a plurality of video cards in accordance with various aspects of the invention.

FIG. 8 depicts a flowchart for controlling a display apparatus in accordance with various aspects of the invention.

### DETAILED DESCRIPTION

In an embodiment of the invention, a 360 degree light emitting diode (LED) display apparatus may comprise a plurality panels of LEDs rotating around a center shaft at an approximate speed of 5,000 rpm (revolutions per minute) to generate a holographic-like image. The holographic-like image that the display apparatus creates is clearer, more fluid in motion, and is able to display realtime graphics. The image display may be composed of three, approximately one hundred twenty degree segments placed side by side around a cylinder. Thus, the apparatus may display images along the circumference of a cylindrical surface. Each segment of the cylindrical surface may independently display an image. The display apparatus may contain computer-executable instructions for an algorithm to control the operation of the device.

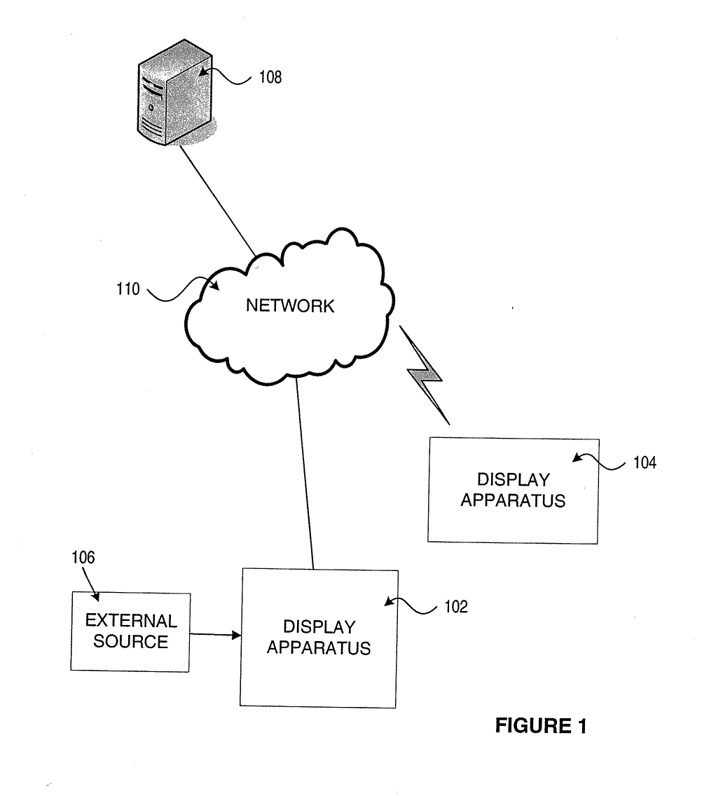

Referring to FIG. 1, a suitable system architecture for communicating data to a display apparatus in accordance with the invention is shown. In the embodiment depicted in FIG. 1, a display apparatus 102, in accordance with various aspects of the invention, receives input from an external source 106. In one example, the external source 106 is a DVD player providing digital video and audio input to the display apparatus 102. In another example, the external source 106 is a player of VHS media and provides analog video and audio input to the display apparatus 102. In yet another embodiment, the external source 106 is any device capable of communicating with display apparatus 102 using a s-video cable.

In an alternative embodiment, display apparatus 102 receives input from an external source (e.g., computing device 108) through a network 110. The external source, in one example in accordance with various aspects of the invention, is a computing device 108 streaming mpeg media content over the Internet (e.g., network 110) to a display apparatus 102. The display apparatus 102 in this example communicates with the network 110 using a wire (e.g., Ethernet cable, fiber optic wire, etc.) In another example in accordance with various aspects of the invention, a display apparatus 104 receives video and audio input from the computing device 108 through the network 110 using a wireless link (e.g., IEEE 802.11 communication, etc.). One skilled in the art will recognize that it may be desirable for the wireless link to support sufficient throughput for realtime image display (e.g., a movie or advertisements). Furthermore, one of skill in the art will appreciate that the above system architectures are merely examples of implementations in accordance with various aspects of the invention and should not be understood to limit the teachings of the invention.

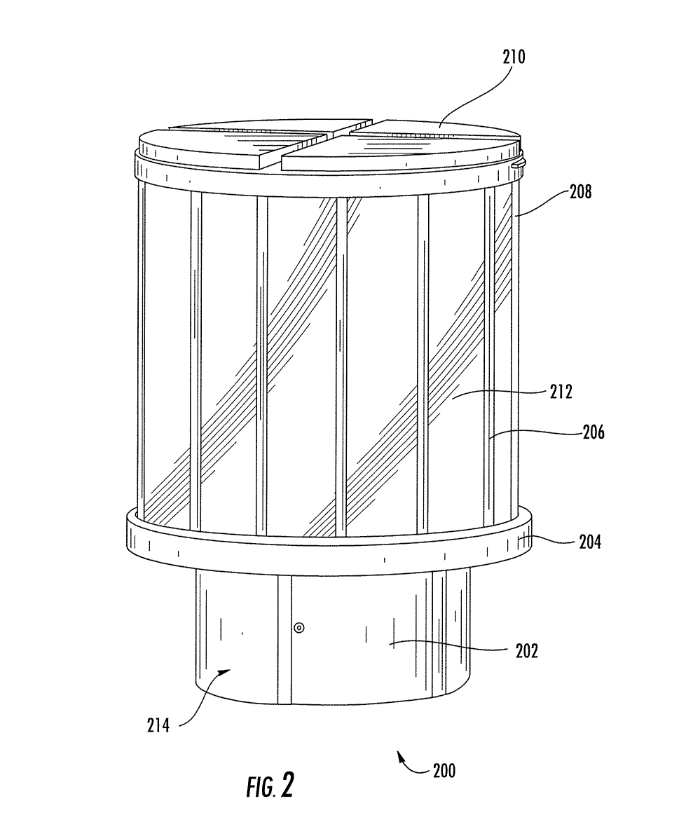

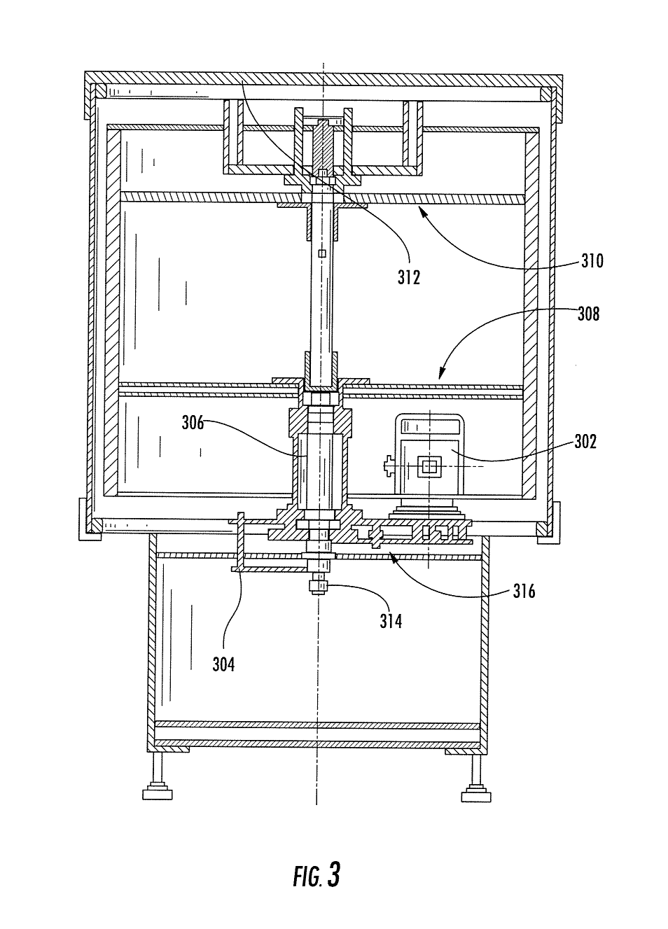

Referring to an illustrative embodiment depicted in FIGS. 2 and 3, in accordance with aspects of the invention, the 360 degree LED display apparatus 200 comprises a static unit on which is mounted an inner cylindrical rotating unit 212, which is protected by a security shield 208. The security shield 208 may be held in place between the lower portion 204 of the static unit and the upper portion 210 of the static unit. In addition, a plurality of panels of light sources 206 may be mounted on the rotating unit 212 between the upper portion and lower portion of the static unit. The upper portion of the rotating unit 212 may provide housing for a primary video card and a plurality of secondary video cards for processing the video input. The front outer view of the illustrative display apparatus is depicted in FIG. 2. Meanwhile, FIG. 3 illustrates a cross-sectional view of some of the internal details of the 360 degree LED display apparatus. Inside the 360 degree LED display apparatus, a central shaft 306 may be anchored at two points. At the bottom of the central shaft, a rotating hub may be found that includes bearing and seals to keep the shaft centralized. A motor 302 connected to a belt system 304 drives or rotates the central shaft. In addition, a rotary sensor 316 may be utilized to determine the rotational speed and/or position of points on the inner cylindrical unit of the 360 degree LED display apparatus. The rotary sensor 316 may be positioned near the bottom of the central shaft 306. For example, the rotary sensor may be positioned between the static unit and inner cylindrical rotating unit such that it may calculate rotational speed and/or position. One skilled in the art will appreciate that FIGS. 2 and 3 illustrate merely depictions of one embodiment of aspects of the invention, and the invention is not so limited.

The static unit of the display apparatus may comprise a cabinet unit 202 at the lower portion of the static unit. The cabinet unit 202 may provide, among other things, structural support for the display apparatus 200. In this example, the cabinet unit 202 houses a control panel and other hardware of the display apparatus. The contents of the cabinet unit 202 may be secured by a door. An operator of the display apparatus may access setting controls on the control panel through this door. The various controls that may be available on the control panel include, but are not limited to, brightness setting control, black level setting control, contrast setting control, color setting control, position setting control, and/or image setting control. The brightness setting control may be used to adjust the brightness of the LEDs mounted on the rotating unit of the display apparatus. The black level setting control may be used to adjust the black level of the backlight. The contrast setting control may be used to adjust the contrast of the LEDs. The color setting control may be used to adjust the color of the display. The position setting control may be used to adjust the horizontal position (i.e., H-position) and/or vertical position (i.e., V-position) of the image within the display. Examples of image setting controls include saturation setting controls for adjusting the depth or intensity of a color, hue setting controls for adjusting the distinction or difference between colors ranging, e.g., from red to blue, and flesh tone setting controls for making flesh colors appear more natural while there is no interference to other source image colors. One or more of the aforementioned image setting controls may be provided in a display apparatus 200 in accordance with various aspects of the invention.

In the example of FIG. 2, the control panel 214 located in the static unit may also be comprised of a video input jack and a processing unit for executing computer-executable instruction. The display apparatus 200 may receive video input from an external source 106 through the video input jack. The external source may be utilized for supplying and storing display information, and providing it to the display apparatus. The display apparatus does not contain memory for storing image data. The display apparatus 200 receives video input from an external source 106 through the video input jack. In one example, the external source 106 may be a DVD player providing video and audio input to the display apparatus 102. In another example, the external source 106 may be a player of VHS media and provides analog video and audio input to the display apparatus 102. The video input may be s-video format, mpeg format, DVD image format, S-VHS image format, VHS image format, VGA image format, or other types of image/video data format known to those of skill in the art.

In some embodiments, the display apparatus may display information in real time. For example, the external source 106 may be an external DVD player. In another example, the external source may be an external networked source, such as a computer 108 streaming mpeg video and/or audio data. It will be apparent to one skilled in the art that a video input jack, in accordance with the invention, is not limited to a physical jack, and includes, for example, a network connection on a network hardware card. The processing unit of the control panel will be discussed below.

Furthermore, in the example of FIG. 2, the inner cylindrical rotating unit of display apparatus 200 is protected by a security shield 208. The security shield 208 may be a transparent material capable of protecting observers from injuries that may result from the rotating cylindrical unit. One of skill in the art will recognize that there are various materials that may be used as a security shield. For example, a clear acrylic material may be used. The acrylic material may be joined at one point with a rubber joint that is also used from inside the security shield to distribute the fiber optic cable from the lower portion 204 to the upper portion 210. In one embodiment, the security shield 208 is held in place between a lower portion 204 of the static unit and an upper portion 210 of the static unit.

In addition, in FIG. 2, a plurality of panels 206 of light sources may vertically span the area between the lower portion 204 of the static unit and upper portion 210 of the static unit. The plurality of vertical panels 206 of light sources may be positioned radially around a central shaft at a predetermined distance (or radius). The plurality of panels 206 of light sources may be connected by a rotating hub to the central shaft 306. In one example, the rotating hub may comprise an upper rotating disk 310 and a lower rotating disk 308. The upper rotating disk 310 may be connected to the central shaft 306 at the center of the upper rotating disk 310. One of skill in the art will recognize that disk, as used herein, includes a disk-like structure with spokes (e.g., like the spokes on a tire). For example, upper rotating disk 310 may be comprised of twelve spokes from the central shaft to each of twelve panels of light sources equally space apart around the central shaft. The lower rotating disk 308 may be a similar structure. At least one benefit of such a disk-like structure with spokes, as opposed to a conventional disk structure, is the reduced weight of the structure, and thus the reduced energy required to rotate the structure.

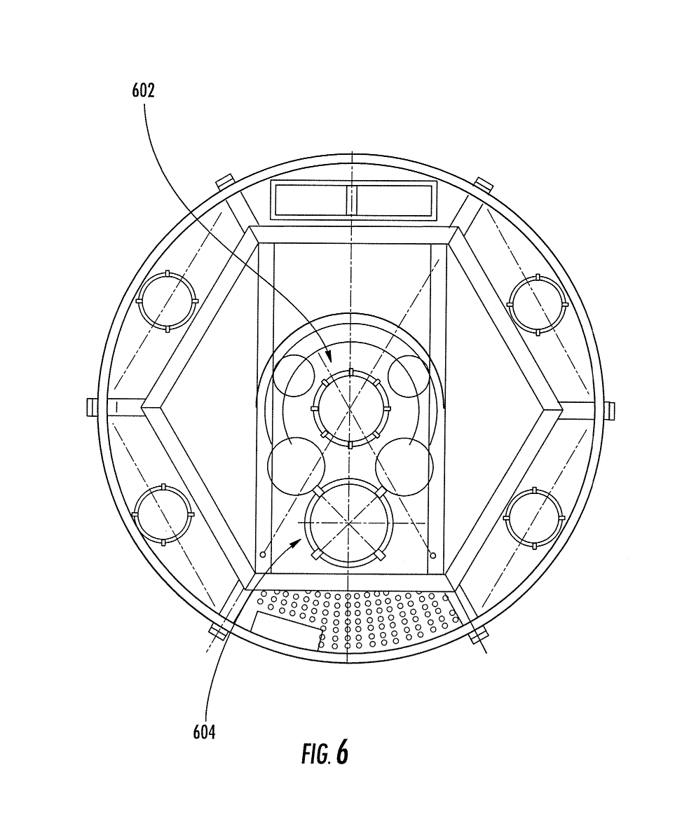

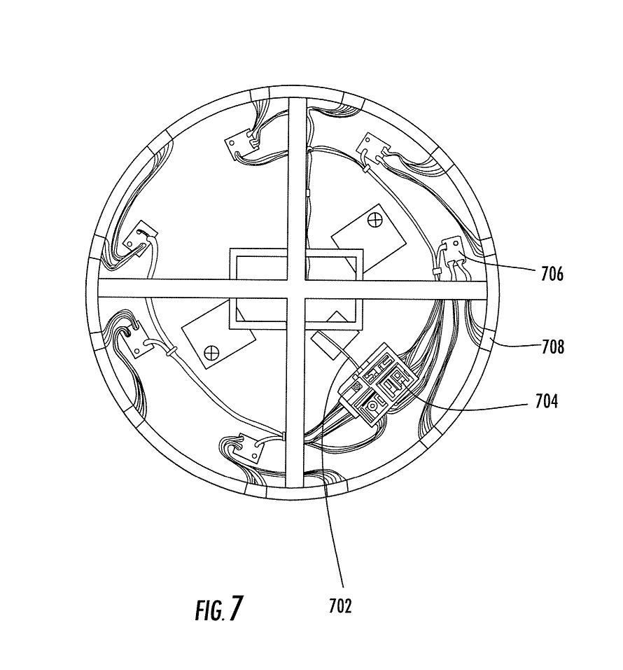

In the example of FIG. 3, a motor 302 with a belt drive system 304 connected to a central shaft 306 on the inner cylindrical rotating unit may be used to rotate the lower rotating disk 308 and upper rotating disk 310. The motor 302 may be a conventional motor capable of rotating the inner cylindrical unit at least approximately 5,000 revolutions per minute. In accordance with various aspects of the invention, FIG. 6 illustrates a cross-sectional top view of the display apparatus 200. The illustration in FIG. 6 shows an example of the interaction between the motor, belt drive system, central shaft, and rotating unit. The central shaft 602 is located at or near the center of the rotating unit and may be surrounded by panels of light sources. A motor 604, located off-center from the display apparatus 200, may use a belt drive system to rotate the central shaft 602 and the plurality of panels of light sources.

In addition, rotating hubs connected to the central shaft on the display apparatus may be comprised of stabilizers 312, 314 to increase the stability of the apparatus as the inner cylindrical unit rotates. For example, ball bearings may be used as stabilizers to keep the central shaft in position and allow it to rotate smoothly. Stabilizers may be used at the top (i.e., top stabilizers 312) and bottom (i.e., bottom stabilizers 314) of the central shaft 306. One skilled in the art will recognize that other means for stabilizing the rotating structure are contemplated and may be used to achieve the same effect.

Furthermore, in accordance with various aspects of the invention, the display apparatus may include a rotary sensor 316 located near the bottom of the central shaft 306. The rotary sensor 316 may be connected through at least a rotation connector to the control panel using a fiber optic wire. The control panel uses the information retrieved by the rotary sensor to operate the display apparatus. The rotary sensor 316 may permit the display apparatus to determine the position of the inner cylindrical rotating unit and its panels of light sources. One skilled in the art will appreciate that other sensors and/or devices may be used to accomplish the function of a rotary sensor, and such equivalents are contemplated by the disclosure herein.

In one example, the display apparatus 200 consists of twelve panels 206 of light sources equally spaced apart around the central shaft 306. Each of the plurality of panels of light sources may be comprised of at least one strip of light sources (e.g., three strips of light sources). The panels may be comprised of a plurality of vertical strips of light sources. For example, a panel may be comprised of a first strip of light sources, a second strip of light sources, and a third strip of light sources. The light sources may, in one embodiment, be light emitting diodes (LEDs). The LEDs may be bulbs that are configured to display one of a plurality of grayscale colors. The strips of LEDs may be organized side-by-side vertically, with the first strip being adjacent to the second strip and the second strip being adjacent to the third strip. Other configuration of the strips will be apparent to one of skill in the art after review of the disclosure.

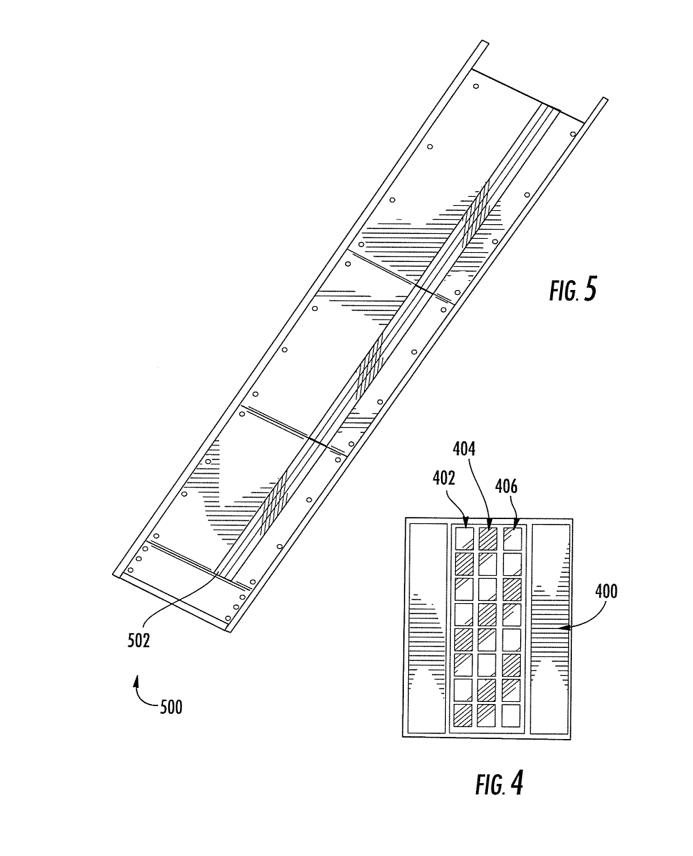

For example, referring to FIGS. 4 and 5, in accordance with various aspects of the invention, a panel 500 of LEDs arranged in vertical strips 502 is shown. The LEDs are divided into three strips. The LEDs are distributed in sections along a display strip, where in this example, each display strip contains 64 colored LEDs. A section 400 of a panel of LEDs is illustrated in FIG. 4. In that section of the panel, the first strip 402, second strip 404, and third strip 406 contains LEDs that may be independently activated to different colors. In one illustrative embodiment, the display apparatus 200 comprises twelve panels of LEDs that are rotated at a speed of approximately 5,000 rpm to generate a holographic image, resulting in an approximate display rate of 56 frames per second, per LED colored light, per strip. The total number of LEDs produces over 16 million true colors that are displayed during the rotational action of the display apparatus. The display apparatus in accordance with the invention does not need to utilize chromatic mixing effects to create different colors at a point on the display. The display apparatus uses light sources that work independently from each other, creating its colored grayscale light within each individual LED.

In another example showing additional detail about the display apparatus 200, FIG. 7 illustrates a cross-sectional top view depicting a primary video card 704 and a plurality of secondary video cards, both located in the inner cylindrical rotating unit. The plurality of secondary video cards may be independently connected to the primary video card, and the primary video card may be connected to the control panel of the display apparatus using a fiber optic wire 702. The video input data received at the video input jack on the control panel may be transmitted to the primary video card 704 through the fiber optic wire 702. In addition, each of the plurality of panels of light sources may correspond to one of the plurality of secondary video cards. For example, a LED at the appropriate location on a panel 708 may be activated at the appropriate time by a single secondary video card 706. In another example, each secondary video card may correspond to a single panel of light sources. Thus, for a display apparatus with twelve panels of light sources, the system would require twelve secondary video cards. Each of the secondary video cards may be operating independently of each other. At least one benefit of this parallel configuration is the enhanced performance and quality that may be achieved by activating the light sources on the numerous panels simultaneously.

Furthermore, the display apparatus 200 may receive audio input, process the audio input, and synchronize the outputted audio with any video display. In one example, the control panel located in the static unit may be comprised of an audio input jack, in addition to the video input jack describer earlier. The display apparatus 200 may receive audio input from an external source 106 through the audio input jack. In one embodiment, the audio input jack and the video input jack may be combined into a single input jack for audio visual (A/V) content. The display apparatus 200 may also include an audio processor and at least one speaker for outputting audio. The audio processor may be hardware or software used for processing the information inputted by an external source and synchronizing the audio signal with any video display. The audio may be outputted using at least one speaker located on the display apparatus 200.

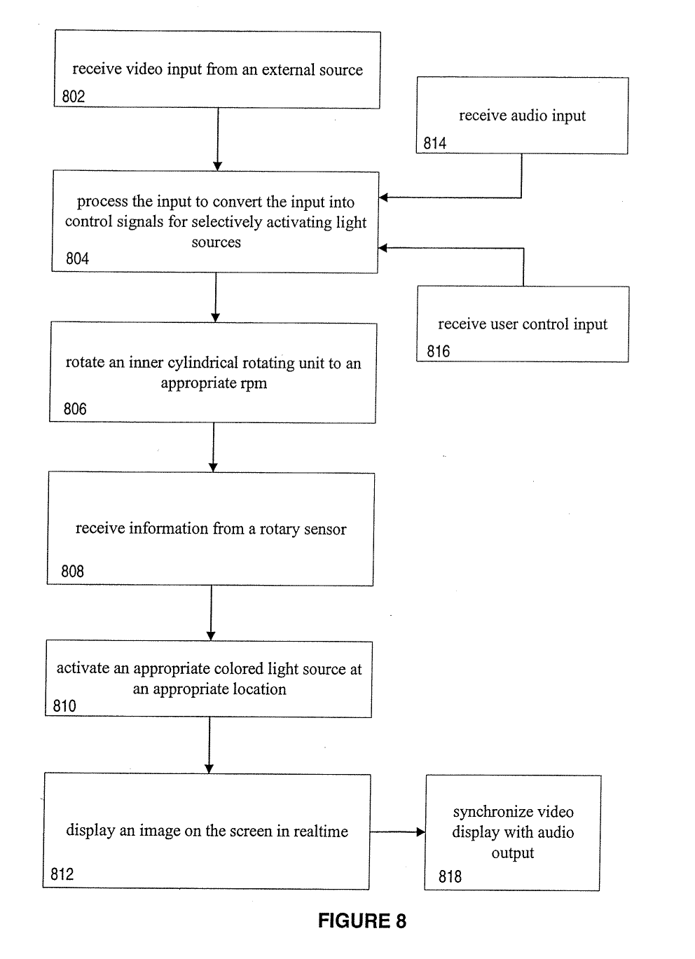

In accordance with various aspects of the invention, FIG. 8 is a flowchart depicting a method for controlling a display apparatus for displaying images. In the example of FIG. 8, the display apparatus may receive video input 802, audio input 814, and user control input 816. The video input and audio input may be provided by an external source, such as a DVD player. The user control input may be provided by the values designated on the setting controls (e.g., brightness setting control, black level setting control, contrast setting control, color setting control, position setting control, and/or image setting control) on the control panel of the display apparatus.

In the example of FIG. 8, the control panel may process the information and transmit the video portion of the information to the primary video card 704 using a fiber optic wire 702. The primary video card may further process the information before transmitting the relevant information to the plurality of secondary video cards. Each secondary video card may process 804 the video input to convert the video input into control signals for selectively activating light sources on a corresponding panel. For example, a secondary video card 706 may generate a control signal that results in a LED in the fourth position from the top of the panel to be activated 810 to a red color. In addition, the control panel may instruct the motor 604 to rotate 806 the central shaft 602 of the inner cylindrical rotating unit to the appropriate rpm (e.g., 5,000 revolutions per minute). The effect of multiple pixel (e.g., LED) impulses and the rotation creates a holographic image taking advantage of a phenomenon known as persistence of vision. In addition, the display apparatus 200 may receive 808 information from a rotary sensor. That information is used, among other things, to regulate the operation of the display apparatus and ensure that the image displayed 812 will be of high quality and in realtime. For realtime display, the above process is repeated for each image to be displayed. If there is audio to accompany the video display, the control panel synchronizes 818 the video display with the audio output. The audio music may be heard from the speakers on the display apparatus.

In addition, as stated earlier regarding the illustrative embodiment in FIG. 2, the control panel of the display apparatus 200 may contain a processing unit. The processing unit may be comprised of a conventional computer processor or microcontroller for executing computer-executable instructions stored in a computer-readable medium. An algorithm executed by the processing unit uses information supplied by the rotary sensor to ensure proper image focus and clarity. The computer-executable instructions perform at least the steps of: receiving video input; processing the video input to convert the video input into control signals for selectively activating light sources (e.g., LEDs); rotating an inner cylindrical rotating unit to an appropriate revolutions per second (i.e., rpm); receiving information from a rotary sensor; activating an appropriate colored light source at an appropriate location (i.e., providing an input to a light source at an appropriate location so that it displays the appropriate colored light); displaying an image on the screen of the display apparatus; receiving audio input; and synchronizing video display with audio output.

The invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A method for displaying an image on a display apparatus comprising a static unit, a rotating unit, a plurality of panels of light sources, a motor, a rotary sensor, a primary video card, a plurality of secondary video cards, and a control panel with a processing unit, the method comprising:
receiving video input from an external source;
processing the video input to convert the video input into control signals for selectively activating light sources;
rotating an inner cylindrical rotating unit to an appropriate revolutions per minute;
receiving information from a rotary sensor;
activating an appropriate colored light source at an appropriate location; and
displaying an image on the screen in realtime.

2. The method of claim 1, further comprising:
repeating the steps of claim 1 for each image to be displayed.

3. The method of claim 2, further comprising:
receiving audio input; and
synchronizing video display with audio output.

4. The method of claim 2, wherein the video input comprise video in s-video format.

5. The method of claim 2, wherein the video input comprises video in mpeg format.

6. The method of claim 1, wherein the appropriate revolutions per second comprises approximately 5,000 revolutions per second.

7. The method of claim 1, further comprising receiving user control input, wherein the user control input comprises information relating to brightness, black level, contrast, color, position, and image, and wherein processing the video input includes processing the user control input.

8. The method of claim 1, wherein a primary video card and a plurality of secondary video cards are used for processing the video input, wherein the secondary video cards operate independently of each other.

9. The method of claim 1, wherein no chromatic mixing effect is required to display the image, and the light sources are light emitting diodes.

10. A display apparatus for displaying images, comprising:
a static unit comprising a control panel, the control panel comprising a video input jack and a processing unit for executing computer-executable instructions;;
an inner cylindrical rotating unit, comprising:
a vertical central shaft; and
a plurality of vertical panels of light sources, wherein the vertical panels of light sources are positioned radially around the vertical central shaft at a predetermined distance, and wherein each of the plurality of panels of light sources is comprised of at least one vertical strips of light sources.
a security shield for protecting the inner cylindrical rotating unit;
a motor with a belt drive system connected to a central vertical shaft on the inner cylindrical rotating unit;
a rotary sensor located between the static unit and inner cylindrical rotating unit;
a primary video card and a plurality of secondary video cards, wherein each of the plurality of secondary video cards is independently connected to the primary video card, wherein the plurality of secondary video cards are located in the inner cylindrical rotating unit, wherein the primary video card is connected to the control panel using a fiber optic wire, and wherein each of the plurality of vertical panels of light sources correspond to one of the plurality of secondary video cards.

11. A display apparatus for displaying images, comprising:
a static unit comprising a cabinet unit at the lower portion of the static unit;
an inner cylindrical rotating unit, comprising:
a central shaft; and
a rotating hub connected to the central shaft and a plurality of panels of light sources, wherein the rotating hub comprises stabilizers;
a security shield for protecting the inner cylindrical rotating unit;
a motor with a belt connected to a central shaft on the inner cylindrical rotating unit;
a rotary sensor located near the bottom of the central shaft, wherein the rotary sensor is connected through at least a rotation connector to a control panel using a fiber optic wire;
a control panel located in the static unit, the control panel comprising a video input jack and a processing unit for executing computer-executable instructions;
a primary video card and a plurality of secondary video cards, wherein each of the plurality of secondary video cards is independently connected to the primary video card, wherein the plurality of secondary video cards are located in the inner cylindrical rotating unit, and wherein the primary video card is connected to the control panel using a fiber optic wire; and
a plurality of panels of light sources, wherein each of the plurality of panels of light sources correspond to one of the plurality of secondary video cards, and each of the plurality of panels of light sources is comprised of a first strip of light sources, a second strip of light sources, and a third strip of light sources, wherein the first strip and the second strip are adjacent and the second strip and the third strip are adjacent.

12. The display apparatus of claim 11, wherein each secondary video card corresponds to a single panel of light sources, and each secondary video card operates independently of other secondary video cards.

13. The display apparatus of claim 11, wherein the rotating hub comprises:
an upper rotating disk connected to the central shaft and a plurality of panels of light sources; and
a lower rotating disk connected to the central shaft and a plurality of panels of light sources.

14. The display apparatus of claim 11, wherein the plurality of panels of light sources consists of twelve panels of light sources equally spaced apart around the central shaft.

15. The display apparatus of claim 11, wherein the video input is provided from an external DVD player.

16. The display apparatus of claim 11, wherein the video input is provided from an external networked source.

17. The display apparatus of claim 11, wherein the control panel located in the static unit further comprises brightness, black level, contrast, color, position, and image setting controls.

18. The display apparatus of claim 11, wherein the control panel located in the static unit further comprises an audio input jack, and the display apparatus further comprising an audio processor and at least one speaker for outputting audio.

19. The display apparatus of claim 11, wherein the display apparatus operates without an internal memory device for storing image data.

20. The display apparatus of claim 11, wherein the display apparatus operates without a polarizer.
